(19) United States
(12) Patent Application Publication
(10) Pub. No.: US 2010/0012225 A1
(43) Pub. Date: Jan. 21, 2010

(54) Device And Method For Decanting Powders And Solid Substances While Avoiding Contamination And Novel Use Of A Weldable And Peelable Tubular Film

(76) Inventor: Viktor Schnyder, Raron (CH)

Correspondence Address: GIBSON & DERNIER L.L.P., 900 ROUTE 9 NORTH, SUITE 504, WOODBRIDGE, NJ, 07095, US

(21) Appl. No.: 12/521,036

(22) PCT Filed: Dec. 12, 2007
(86) PCT No.: PCT/IB2007/055059

§ 371 Date: Aug. 7, 2009

(30) Foreign Application Priority Data
Dec. 24, 2006 (CH) 02135/06

(51) Int. Cl. B65B 1/04; B23P 11/00

(52) U.S. Cl. 141/370; 29/428

(57) ABSTRACT

A device and a method for decanting powders and solid substances or materials while avoiding contamination and a novel use of a weldable and peelable continuous tubular film (1). The invention provides a basic version, with which it is simply possible to work free from contamination and a further-developed form, with which it is also possible, in addition to avoiding contamination, to perform decanting under sterile conditions.

The invention relates to a device and a method for decanting (emptying and/or filling of containers, such as bulk good containers or silos or the like) while avoiding contamination. The steadily rising requirements for industrially produced products or also for the purity of agricultural products such as grains, flours, or the like also result in ever higher requirements for the raw materials and components which are used. The products have an ever higher degree of specialization, i.e., ever higher degrees of purity, more and more active and valuable materials, and possibly also more and more hazardous materials.

The problems go in two directions. On the one hand, in the field of operator protection: an operator cannot be subjected to any hazard and, on the other hand, in the field of product protection: the product cannot be stressed or contaminated with foreign materials, bacteria, etc.

These are general requirements, which occur above all in biotechnology, food, chemical, and pharmaceutical areas of industry and possibly also in food technology and agriculture and medicine.

In order to meet these requirements, the products to be processed are not handled open, but rather in closed transport containers, such as fixed transport containers, flexible transport containers (also called big bags), or barrels. All transport containers may additionally be equipped with a film inner bag (inner liner).

The question arises as to how these transport containers can be emptied and filled while avoiding contamination.

While costly and complex docking systems such as divided flaps, cone systems, or the like are already available for the fixed transport containers, no satisfactory solution exists for transport containers having flexible outlet and/or intake, which reliably prevents the contamination of an operator and/or the escape of decanting material during the decanting procedure.

The problem is that up to this point there has been no clean possibility for connecting transport containers having flexible outlet in a form closed to the surroundings at a product intake or product outlet of a facility or a system and to remove the emptied or filled container after the emptying or filling again completely free of contamination.

A facility is understood in the meaning of the invention as arbitrary containers in which something is located, which is subsequently to be in another container and/or in another apparatus. In many cases, the products are stored and processed in containers. However, they may also be solids or objects which come out of an isolator. Therefore, the term facility is used hereafter, which also comprises the term container or isolator and/or also a space in the broadest meaning. For the same reason (broadest interpretation) any container in which decanting is to be performed is referred to as an apparatus hereafter.

Systems up to this point have used mechanical clamping apparatuses for the attachment of the containers, the outlet being clamped and sealed on the attachment system. Upon changing of the container, however, both the attachment system and also the container are open. Soiling at the attachment point and contamination of the operator and the surroundings may occur due to dust-charged air and due to trickling residual product.

An improvement of this known technology is described in WO-2005056443. An attempt is made therein to provide a method for low-contamination emptying and/or filling bulk good containers while employing protective films.

A tubular film is used therein, which connects one container to the other container and is connected at one or more binding points to the containers before the decanting so that nothing can escape between film and container during the decanting. In particular, a procedure according to the following steps is used:

situating a container to be emptied having an outlet bound at a binding point above an attachment pipe,

situating a tubular film around the attachment pipe so that it presses against the intake-side edge of the attachment pipe to form a seal,

binding the tubular film above the attachment pipe so that a funnel-shaped expandable end of the tubular film remains above the binding point, clamping connection of outlet of the flexible container and the tubular film so that free tubular film remains above the clamp connection,

loosening the binding points of outlet and tubular film and thus emptying the bulk good,

gathering the free end of the tubular film remaining above the clamping point against the container outlet and fixing it thereon,

drawing out tubular film from a tubular film supply, until clean tubular film is available above the attachment pipe,

closing the tubular film at two adjacent closure points in the clean area,

cutting through the tubular film between the two closure points, drawing out tubular film from the tubular film supply and binding it again at a binding point at a distance from the cutting point,

removing the closure point in the area of the cutting point and spreading out the tubular film between the cutting point and the binding point, which is located at a distance from the cutting point, into a funnel shape.

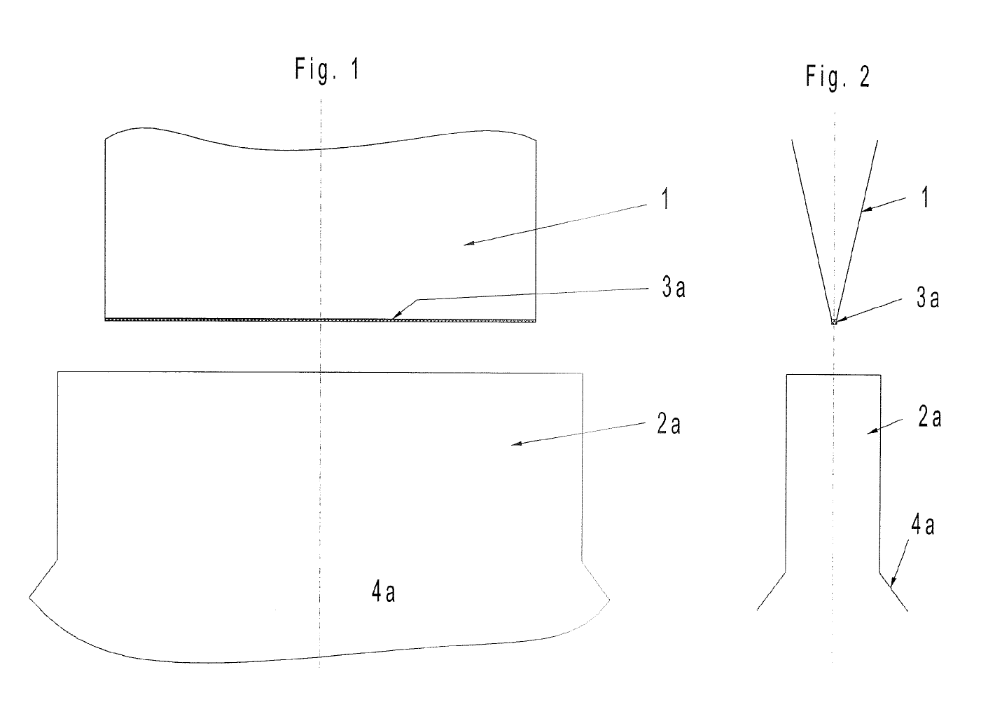

However, manipulation completely free of contamination does not occur through this binding method with incorporation of attachment pipes. At the binding point [3.1] (cf. FIG. 1), the inner side of the tubular film, which was contaminated on its inner side, is exposed upon the transfer from one decanting procedure to a next decanting procedure. Material can thus escape from the inner side of the tubular film into the surroundings.

The known method is thus advantageous in relation to other known solutions, but is not actually optimal in regard to avoiding contamination. Above all in the further transport and/or in the further manipulation using the facilities and apparatuses, contamination is not precluded.

The invention is thus based on the object of providing a novel method and a novel device which ensure complete avoidance of contamination.

This object is achieved by the method according to Claim 1 and by a device according to Claim 5, and in particular by the novel use of a weldable and peelable endless tubular film according to Claim 10. In addition, Claim 15 discloses an improved method for not only contamination-free, but rather also sterile decanting. Claim 20 relates to a device which is supported on this improved method.

The essential part of the novel device and the novel method is the use of a weldable peelable endless tubular film in connection with a complete replacement of the known binding method by welding methods. In particular also at the binding point [3.1], which expressly cannot be welded according to the known WO-A. Through the welding according to the invention even at this point, it is firstly ensured that any contaminating coatings of the tubular film remain captured (fused) in the weld seam and cannot be discharged to the surroundings. Secondly, the peeling capability of the endless tubular film according to the invention makes it possible that, after the welding to the intake, the connection between container and apparatus can be produced without having to perform manipulations using the binding thread. Peeling ability is understood as the property in which a plastic film which is welded—possibly to itself—can be detached again at the weld seam, as if it had never been welded. This relates in particular to treated and/or produced films, which have this property. This technology is mostly already used in plastic packages, in order to make opening the package easier for a customer.

In addition, it is obvious and advantageous in the invention if the endless tubular film is not tightened around the intake—i.e., typically on the bottom, as in the known devices—but rather around the outlet. This advantageously provides the feature that complex clamping devices, etc., may be dispensed with, because the endless tubular film is drawn out from top to bottom, and then remains hanging in suspended form, i.e., requires no additional retention. Finally, this circumstance also provides the advantage that the funnel shape of the endless tubular film may be dispensed with (cf. to FIG. 8 of WO-A), because particularly this necessity in the prior art results in the exposure of a large contaminated surface, namely the inner side of the funnel.

The advantage also results in particular through the novel devices and the novel methods that the facilities and apparatuses are optimally closed after the decanting according to the invention using the endless tubular film and thus require no additional closing devices, which overall improves not only the purity of the method but rather also its efficiency in relation to typical systems.

Arbitrary apparatuses, which are known per se such as a radial expansion ring according to the cited WO-A, can be used for holding the endless tubular film. In this regard, reference is expressly made to the expansion ring 9 from the figures of the WO-A and to the associated explanatory parts of the description, which are thus incorporated herein as by reference.

The method and the construction of the invention are explained and further advantages are disclosed hereafter.

The method is set up so that it is best suitable for the decanting of bulk goods, i.e., powders and solids, for example, while avoiding contamination. In addition, however, there is still a further application in medical technology and surgery. For example, during organ transplants, the transport of organs or tissues necessarily occurs, which must be conveyed as much as possible in a sterile and contamination-free manner and possibly must be repacked. Such tissues and/or organs and the like may also be optimally decanted using the solutions according to the invention. According to the invention, the goods are decanted from a facility having a possibly flexible outlet into a downstream apparatus having a weldable intake of an inner liner in the form of a tubular film, the method having the following method steps.

Such facilities are standard in greatly varying forms (silos, transport bags, isolators, clean rooms, etc.) and do not have to be explained in greater detail. Vessels (apparatuses) having inner liners are also standard and frequently used. The inner liner is to keep the received material back from the actual container, into which the decanting is to be performed, and thus impede contamination of apparatus and/or material.

As the first step, an endless tubular film, which is weldable on its outer side and inner side, the inner side being peelable after welding, is attached around the outlet of the facility, in such a way that it may be drawn like an elongation of the outlet along its longitudinal extension. The endless tubular film is fixed, for example, using an expandable ring on or over the outlet, so that it can be pulled out further until it is used up. The endless tubular film is preferably folded similarly to a folded bellows for this purpose. This is known per se and has the advantage that the transport and storage and the repositioning of endless tubular film are simple.

If the endless tubular film is welded on its free end in the mounted state, it thus closes the outlet. This is a simple and reliable method. It is much less costly and cleaner than typical flaps, etc., because possibly different materials are stored in a facility in sequence, the flaps, valves, etc. must typically be cleaned especially well in particular. However, if the endless tubular film assumes this valve function, this effort is dispensed with. A method cycle begins with the welding of the endless tubular film.

Of course, this welding may also already be performed at the first point of the endless tubular film in the tubular film production factory, so that after the endless tubular film is pulled out, initially no manipulation has to occur, but rather the facility may in turn be filled with the material. However, the invention also comprises mixed variants, i.e., variants which have valves in addition to the endless tubular film.

As soon as the endless tubular film is in its position, the intake of the apparatus into which decanting is to be performed is situated, around the outer side of the endless tubular film so that the intake-side edge of the intake comes to rest above the welded point of the endless tubular film.

Material is now preferably pressed back from the endless tubular film in the direction of the facility, so that the inner sides of the endless tubular film come to rest one against another and the inner side of the intake is seated with total surface contact on the outer side of the endless tubular film.

The welding of the endless tubular film to the intake is then performed, so that at least one continuous new weld seam arises on the endless tubular film between its existing weld seam and intake-side edge of the intake, which on the one hand connects the inner side of the intake to the outer side of the endless tubular film and on the other hand connects the inner side of the endless tubular film at the same point. The welding procedure may be performed using typical pulse welding apparatuses, or also by thermal welding or using laser welding in the transmission beam method, for example.

By subsequently removing the peelable inner side of the endless tubular film, the two weld seams in the interior of the endless tubular film are peeled so that the facility is connected to the apparatus via a laterally closed tunnel. The decanting procedure may thus occur, as long as the endless tubular film is welded through again—preferably after prior material displacement by construction at a third point—and suppresses the material flow in this way.

This third welding corresponds to the first and the cycle is closed, and/or the next apparatus can be filled.

The welding is preferably performed at the third point widely enough that subsequently the cutting through of the endless tubular film occurs in the area inside the weld seam—preferably approximately centrally. The welding may also be executed at the third point as a double weld seam having a central partition seam.

The mount of the endless tubular film is preferably a tubular film carrier, which possibly operates using an expanding ring or the like for the fixing.

A practical welding method results if the welding is performed using pulse welding technology, and/or if, before the welding, the endless tubular film is pressed together using clamping bars, so that the material in the area of the later weld seam is displaced upward/downward into the tubular film as much as possible. The bars and welding rollers, welding electrodes, or the like are preferably implemented as integrated, so that they also use the bars as a guide.

Pulse welding technology is preferably used according to the invention. Other comparable welding technologies, such as ultrasonic technology or laser welding technology may also be used, however.

A device according to the invention for the decanting of bulk materials without contamination and in particular for performing a method as disclosed above is disclosed in claim 5.

This device is refined by dependent claims 6 through 9.

The welding device is preferably a pulse welding device and/or also comprises a cutting device, which may preferably cut through the endless tubular film approximately in the middle of the weld seam. Specifically, if a cut is made to the welded area, it is ensured that contaminated surfaces are not exposed at all. Any contaminations are and remain bound in the weld seam.

Polyethylene is available as a typical plastic for the endless tubular film, from which the inner liners are typically also produced. However, the invention is in no way restricted to polyethylene.

Because endless tubular films are already known per se, the novel use according to the invention of such a film for the decanting of materials from a facility into an apparatus is also placed under protection in Claim 10.

Endless tubular films have also, of course, been known for some time, as also disclosed in the WO-A. However, until now no such endless tubular films having peelable inner side have been used for decanting procedures. Until now, they were only used for packaging purposes, in that a packet is prepared from the tubular film, which can be opened by peeling. Typical exemplary application: potato chip packages or the like.

Further Claims 11 through 14 disclose still further refined details of the use. The method according to the invention for the sterile decanting of solids while avoiding contamination from a facility having flexible outlet into a downstream apparatus having a weldable intake of an inner liner in the form of a tubular film is disclosed in Claim 15 and has the following method steps:

It is to be noted that this novel method is based in principle on the usage principle of a weldable peelable endless tubular film and thus represents a coherent invention with the method and devices and/or uses described above.

Situating an internally sterile endless tubular film, which is peelable on its outer side and inner side, the inner side being peelable after welding, around the sterile outlet, welding the endless tubular film on its free end, adapting a sterilized bag to the intake of the inner liner and sterilizing the bag having inner liner, the bag having been constructed as follows prior to the welding to the intake of the inner liner:

A tubular transition film (violet), which is not internally weldable but is already externally weldable, is weldable on its outer side to the inner side of the intake and is connected using its side facing away from the intake to the bag-shaped sealing film, whose bag floor is inside the transition film and whose bag edge is connected to the side of the transition film facing away from the intake, for example, welded, a plastic which is well weldable being selected for the sealing film;

situating the bag-shaped sealing film around the outer side of the endless tubular film so that the welded part of the endless tubular film comes to rest inside the bag;

preferably pushing back material out of the endless tubular film in the direction of the facility, welding the endless tubular film to the sealing film, so that at least one continuous new weld seam, preferably a double weld seam, arises on the endless tubular film between its existing weld seam and the free edge of the sealing film, the new weld seam connecting the inner side of the sealing film to the outer side of the endless tubular film, on the one hand, and connecting the inner side of the endless tubular film at the same point, on the other hand, during this welding procedure, a partition seam being placed in the middle of the weld seam, preferably between the double weld seams, so that the part of the endless tubular film facing away from the outlet is cut off in the form of a token including material together with the sealing film surrounding it.

The welding and cutting through is caused externally through the transition film, without welding or cutting through the transition film itself. Because this inner layer of the transition film is not weldable, no connection of the films occurs.

Subsequently, the peelable inner side of the endless tubular film is detached at its second welded point, so that the decanting procedure occurs until the endless tubular film is again welded through at a third point and prevents the material flow in this way.

The sealing film is preferably selected from pure polyethylene, because it is thus continuously weldable.

The manipulation is especially simple if the bag is welded tightly to the inlet, then sterilized, preferably Y-sterilized, and supplied as an accessory to the decanter.

In order to simplify the cutting through, the welding may be performed so widely at the third point of the endless tubular film, and the cutting through of the endless tubular film may subsequently occur in the area inside the weld seam—preferably approximately centrally—after which a new filling/decanting procedure may again occur in a new apparatus. Alternatively, a double weld seam having central partition seam may be applied to the endless tubular film at the third point.

The tokens obtained as a waste product may remain in the apparatus—if it does not interfere—and be disposed of after emptying the apparatus. However, it may also be removed through the outlet.

It is to be noted that the invention is not restricted to such methods, in which the decanting procedure occurs from top to bottom. Methods are also included in which the facility is in one level relative to the apparatus and the endless tubular film is therefore situated horizontally.

A device for the sterile decanting, which avoids contamination, of bulk materials and in particular for performing a method according to one of the preceding statements is described and/or placed under protection in Claim 20. Refinements result from the claims dependent thereon.

The bag-shaped sealing film is preferably implemented together with the tubular transition film as a bag which is connected fixed to the intake of the inner liner and sterilized. Such a packet (bag having inner liner) can be transported and mounted without problems—even packed sterile.

The invention is explained in greater detail hereafter for exemplary purposes on the basis of exemplary embodiments. In the schematic figures:

FIG. 1 shows a view of a welded endless tubular film above an intake of an inner liner to be filled;

FIG. 2 shows a side view of the illustration of FIG. 1;

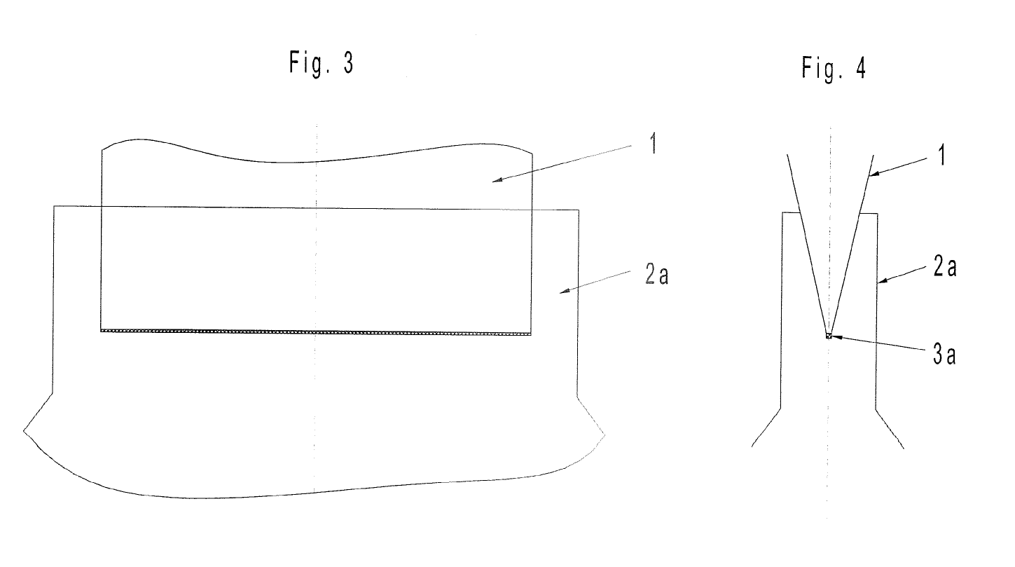

FIG. 3 shows a view of the welded endless tubular film of FIG. 1 after the insertion into the intake of the inner liner to be filled;

FIG. 4 shows a side view of the illustration of FIG. 3;

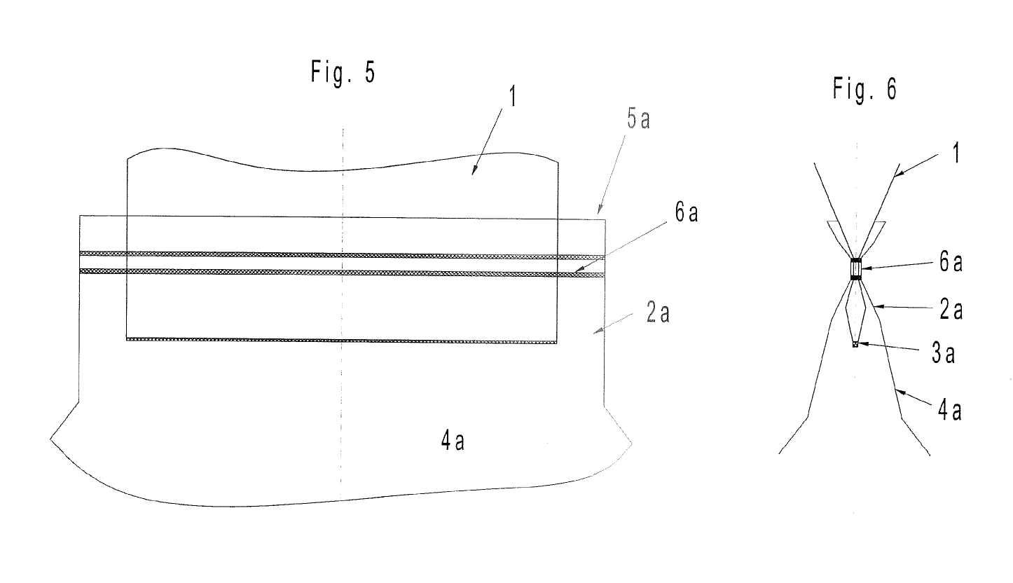

FIG. 5 shows the view of FIG. 3 having applied weld seam;

FIG. 6 shows a side view of the illustration of FIG. 5;

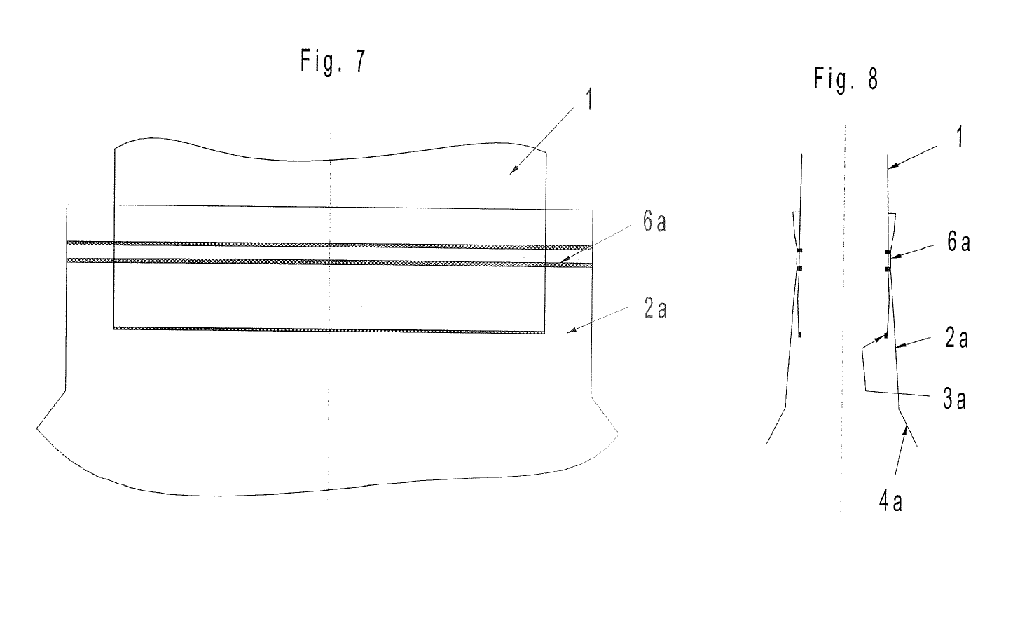

FIG. 7 shows a view of a welded and subsequently peeled endless tubular film according to FIG. 5;

FIG. 8 shows a side view of the illustration of FIG. 7;

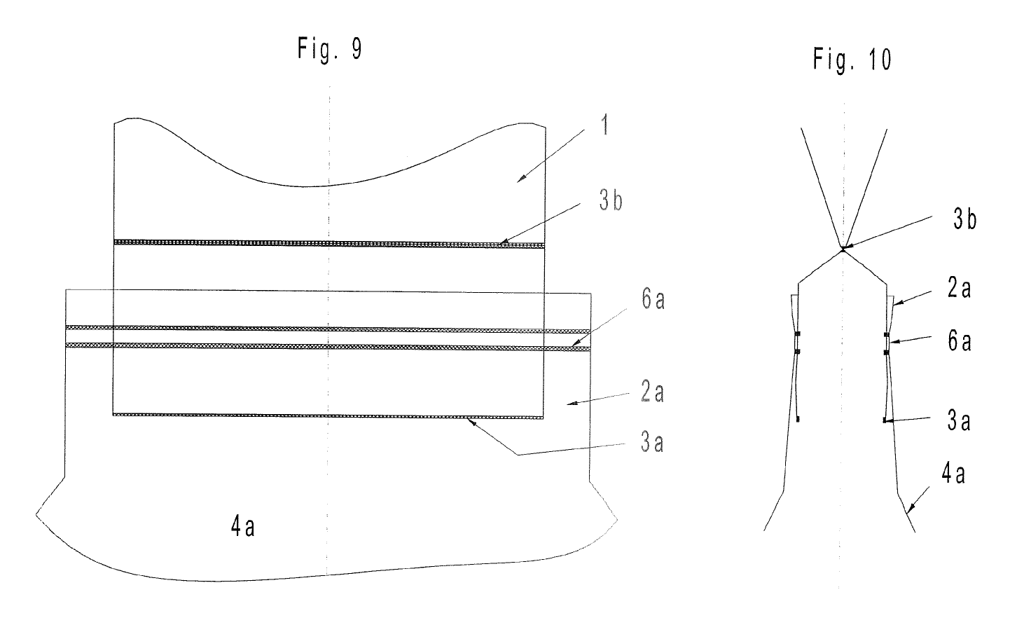

FIG. 9 shows a view of the peeled endless tubular film according to FIG. 7, which is subsequently welded again at a third point;

FIG. 10 shows a side view of the illustration of FIG. 9;

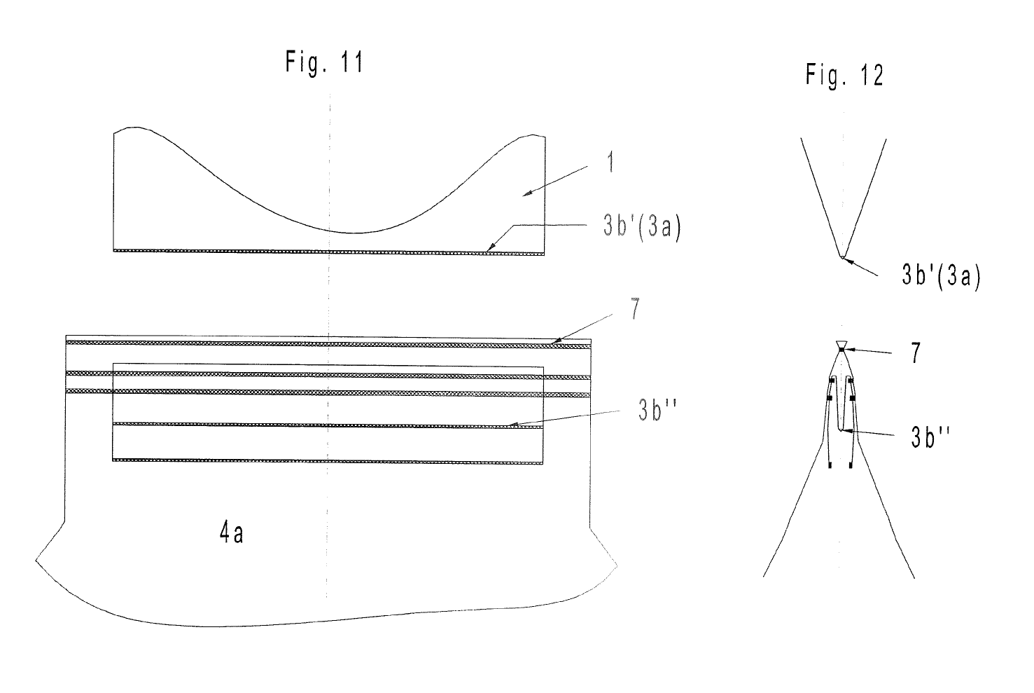

FIG. 11 shows a view of the endless tubular film, which was welded again at the third point and cut through there, above the intake according to FIG. 9, the free-standing ends of the inner liner being welded;

FIG. 12 shows a side view of the illustration of FIG. 11;

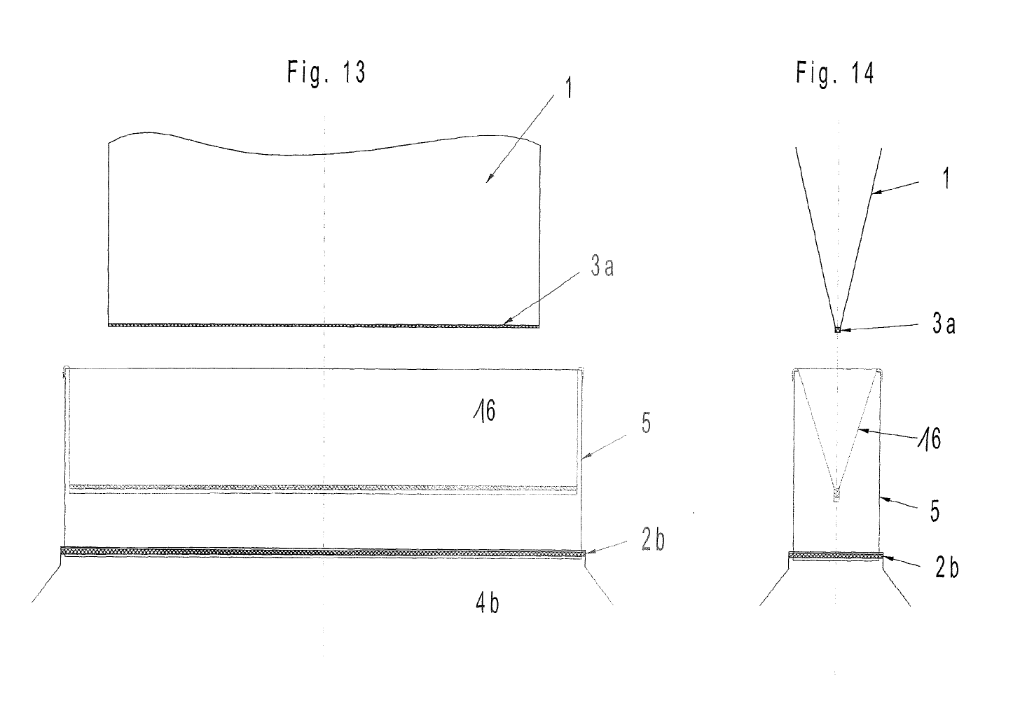

FIG. 13 shows a view of an endless tubular film according to FIG. 1 above a bag according to the invention on an intake;

FIG. 14 shows a side view of the illustration according to FIG. 13;

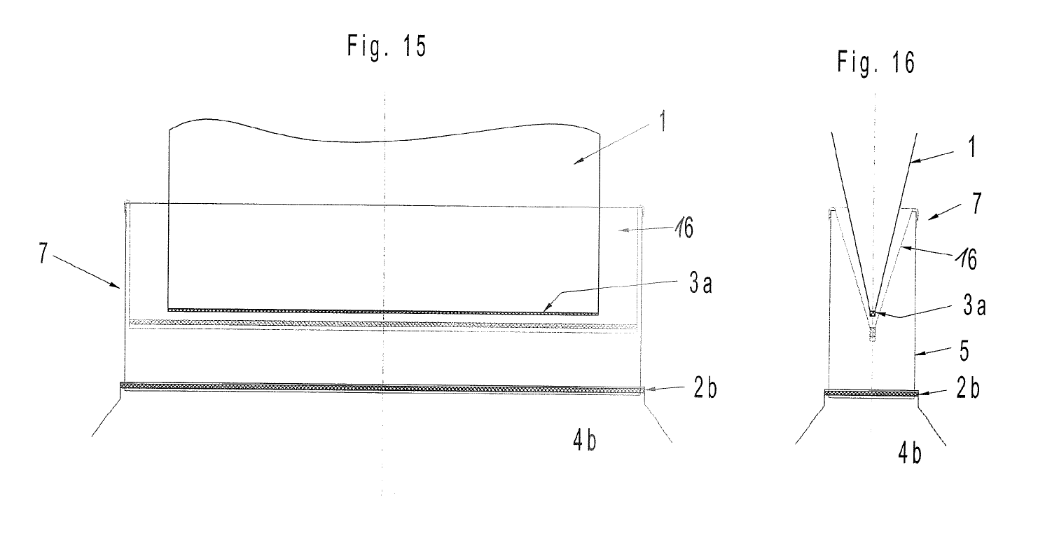

FIG. 15 shows a view of the construction according to FIG. 13, the endless tubular film having been inserted into the bag;

FIG. 16 shows a side view of the illustration according to FIG. 15;

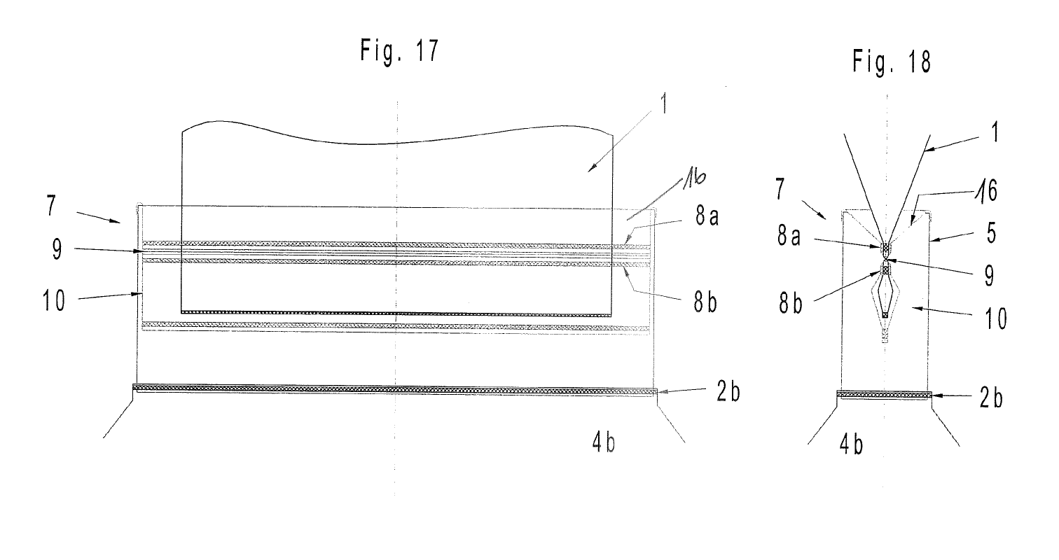

FIG. 17 shows a view of the illustration according to FIG. 15, but with additionally applied weld seam at a second point;

FIG. 18 shows a side view of the illustration according to FIG. 17;

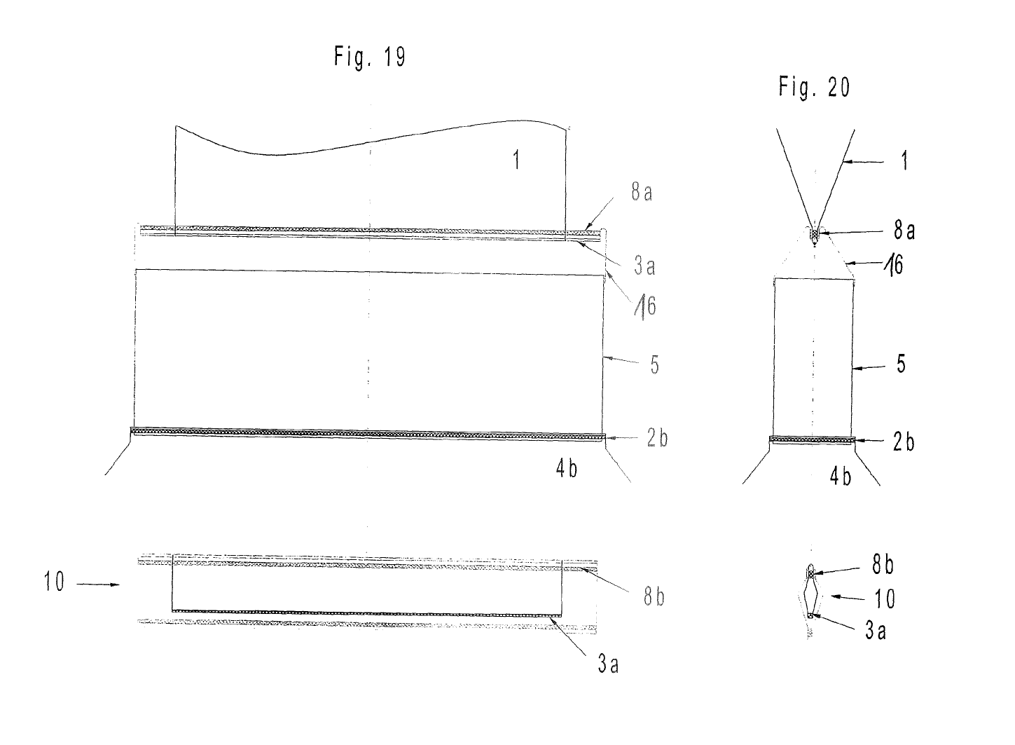

FIG. 19 shows a view of the illustration according to FIG. 17, but with a cut-off token;

FIG. 20 shows a side view of the illustration of FIG. 19;

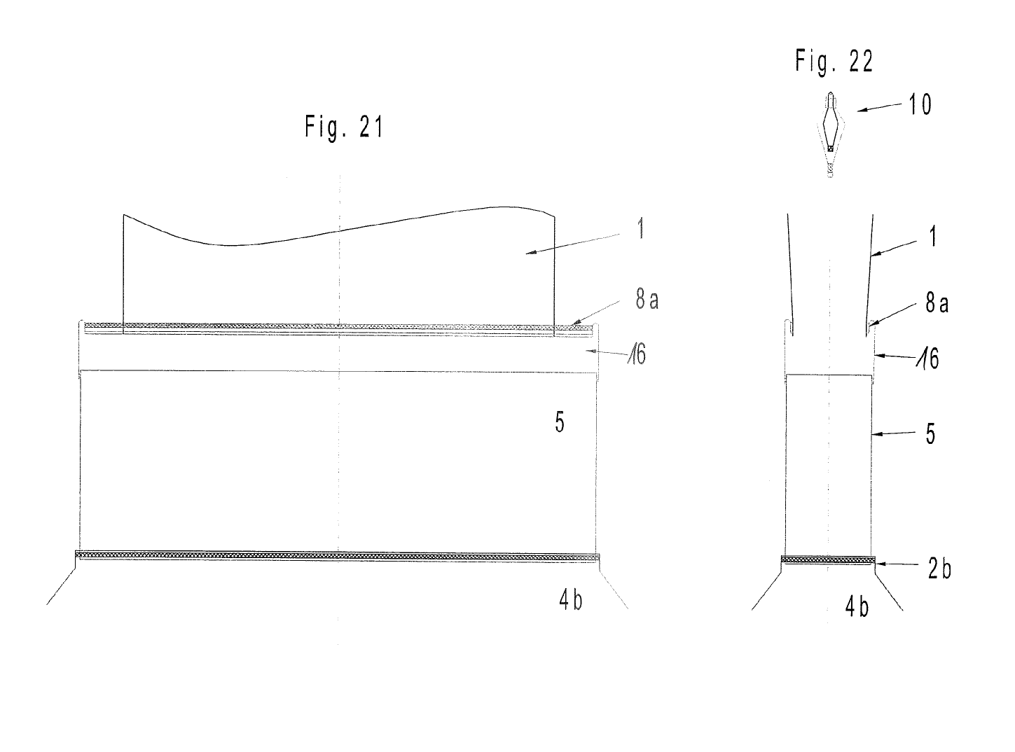

FIG. 21 shows a view of the construction according to FIG. 19, the endless tubular film having been peeled open (opened) at its first welded point;

FIG. 22 shows a side view of the illustration according to FIG. 21; and

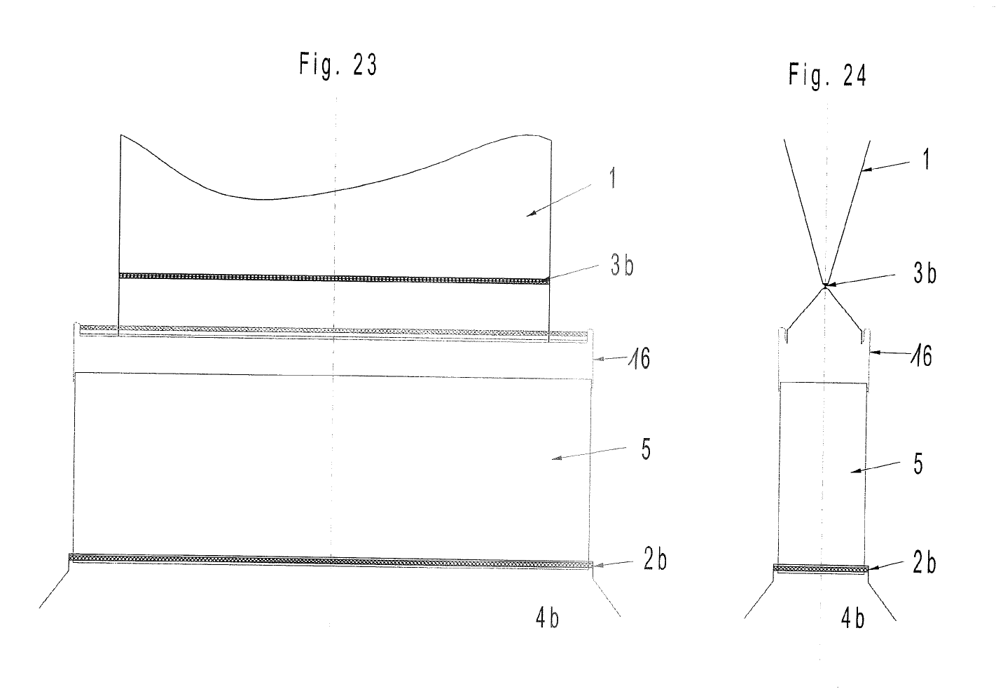

FIGS. 23 and 24 shows the construction of FIG. 21 after a cutting weld was applied again on the endless tubular film at a third point.

The cutting through of the endless tubular film after the application of the partition weld at the third point of the endless tubular film is not shown. Reference is made in this regard to FIGS. 11 and 12, the welding of freely protruding remainders of the intake also being able to be dispensed with here, because the cut-off bottom part of the endless tubular film is already used as a closure of the inner liner and/or intake.

The figures are described coherently and overlapping. Identical components bear identical reference numerals. Similar components or functionally-similar components bear identical reference numerals having different indices.

FIGS. 1 and 2 Show the Starting Situation:

An “endless” endless tubular film 1, which is closed on top, and which is weldable on its outer side and is weldable and peelable on its inner side (blue), is fastened on the facility (not shown) in the form of a preferably axially folded endless liner.

The endless tubular film is originally welded or is welded from the last cutting at the bottom and/or on its end 3 facing toward an intake 2a. The process is thus kept closed.

The intake is a component of an inner liner 4a to be filled of an apparatus (not shown). The intake 2a of the inner liner 4a must be internally weldable. It is open and therefore possibly not sterile in this embodiment.

This construction is thus used less for the protection of the product to be decanted, but rather for the protection of the operator from contamination.

FIGS. 3 and 4 show the next step, in which the free welded end 3a of the endless tubular film is inserted into the inner liner 4a to be filled and/or its intake 2a.

FIGS. 5 and 6 disclose the procedure of the welding according to the invention:

Using a typical welding device, the endless tubular film 1 and the intake 2a of the inner liner 4a to be filled are continuously welded to one another (second weld seam 6a). The part 5a projecting beyond the broad side of the endless tubular film 1 is also welded through. Complete contamination protection thus results, because no material can thus escape between endless tubular film 1 and intake 2a. Notwithstanding this, a tight, non-peelable weld seam arises between the outer side of the endless tubular film 1 and the inner side of the intake 2a. The endless tubular film 1 is welded to itself on its inner side.

FIGS. 7 and 8 show the procedure of opening the tubular connection to allow the decanting procedure: the first weld seam 3a and the second weld seam 6a are peeled, i.e., an operator grasps the endless tubular film 1 externally and pulls the seams apart, the inner weld seams 3a and 6a peeling open. The opening and/or the peeling open may also optionally be performed by the possibly slightly increased inertization pressure of the material from the facility.

The welding between the outer side of the endless tubular film 1 and the intake 2a remains in existence. The inner liner 4a is thus tightly connected to the facility and/or its outlet (not shown). The inner liner 4a is filled in this state.

FIGS. 9 and 10 show the procedure of terminating the filling procedure. After the filling, the endless tubular film 1 is preferably cut off at a partition weld seam 3b. A partition weld seam 3b is a weld seam which allows the separation of the two parts which abut the weld seam after the welding procedure. The two parts remain welded at the ends facing toward one another.

The decanting process in the facility and in the apparatus is thus closed, because the partition seam forms a boundary weld as noted. The weld seam 3b corresponds to the weld seam 3a during a new cycle.

FIGS. 11 and 12 show the next step, in which the inner liner 4a is preferably closed once again at its upper end, in that the free ends of the intake 2a are tightly welded at a fourth point 7. Prior to this, the welded (3b″) remainder of the endless tubular film 1 is laid and/or inserted into the intake 2a.

A closed package of the inner liner 4a with the completely enclosed material thus results. Both endless tubular film 1 and also inner liner 4a remain completely free of contamination on their outer sides.

The same property, but additionally also sterile operating conditions, i.e., no substances, bacteria, or the like from the surroundings may be introduced into the material to be decanted, is implemented by the refined method described below; i.e., the inner sides of the films never come into contact with the surroundings during the entire decanting process, while in the method described above, the inner sides only do not come into contact with the surroundings if they do not come into contact with the decanting material and not only the outer sides are free of material.

FIGS. 13 and 14 show the starting situation for the sterile and contamination-free decanting method according to the refinement of the invention:

The endless tubular film 1 is fastened on a facility, which is constructed under sterile conditions, (e.g., in a clean room), in the form of an endless liner around the outlet of the facility (not shown). The endless tubular film 1 is internally peelable and externally weldable. The endless tubular film 1 is welded on the bottom 3a—for example, still from the last cutting through. The inner liner 4b to be filled has a short intake 2b, which is welded to a special tubular transition film 5. The transition film 5 is internally non-weldable and externally weldable. The transition film 5 is welded edge-tight on its side facing away from the intake 2b to a bag-like sealing film 16. The sealing film 16 is made of pure polyethylene and is weldable well on all sides. The inner liner 4b is welded tightly to the transition film 5 and can be gas or gamma sterilized. The entire packet can thus be supplied in a sterile package, for example, and inserted into the apparatus on location (e.g., in the clean room).

FIGS. 15 and 16 show how endless tubular films are specially inserted into the special intake construction comprising transition film 5 and sealing film 16, implemented welded to the intake as a bag 7: the endless tubular film 1 is inserted into the bag-shaped recess of the sealing film 16 of the inner liner 4b to be filled. The outer sides of the sealing film 16 thus contact outer sides of the endless tubular film 1. The outer side is understood in this case as the side which comes into contact with the surroundings. From the viewpoint of the bag 7, it is therefore more of an inner side as a result of the bag implementation of the sealing film 16, however. However, for clarity in speech, outer side in the above meaning is always referred to here.

FIGS. 17 and 18 show the procedure in which the endless tubular film 1 and the sealing film 16, which are inserted one into the other, are welded: using a welding device (not shown, because it is typical per se), the endless tubular film 1 and the sealing film 16 are welded to one another, so that two tight weld seams 8a, 8b arise between the endless tubular film 1 and the bag 7. In this procedure, the endless tubular film 1 is also welded. During the welding procedure, a partition seam 9 is placed between the weld seams 8a and 8b. This separates the nonsterile part in the form of a token 10. The welding and cutting through is performed externally through the transition film 5. Because its inner layer is not weldable, no connection of the inner side of the transition film 5 to the inner side of the sealing film 16 or to the endless tubular film 1 occurs.

FIGS. 19 and 20 show the procedure of cutting off the token 10: the token falls downward into the inner liner 4b and remains as a sterile foreign body in the decanting product, or it is removed from the side of the facility (e.g., if the facility is implemented as an isolator). (FIGS. 21, 22). However, it may also be a horizontal conveyance process.

FIGS. 21 and 22 show the procedure of peeling open, in which the endless tubular film 1 and with it the sealing film 16 are opened. The welding between the endless tubular film 1 and sealing film 16 remains in existence, in contrast. The inner liner 4b is thus connected tightly to the facility and/or its outlet.

The welded token 10 is removed as a waste part from the isolator (facility) in this exemplary embodiment. In this state, the inner liner 4b is filled or emptied in a sterile manner.

The cycle closes with the steps shown of FIGS. 23 and 24.

Partition Welding Occurs:

after the filling, the endless tubular film 1 can be partitioned off using a partition weld seam 3b. The process in the facility and also the inner liner 4b are thus closed and sterile, because the partition seam 3b triggers edge welding.

For a new decanting procedure, the partition seam 3b having its boundary weld would correspond to the weld seam 3a on the endless tubular film 1.

Methods which replace the “welding” by “gluing” are also within the scope of the invention, if the glued bonds have the same properties in regard to the peeling ability as specified above for the welding. “Welding” is therefore to be understood in a very broad meaning.

### LIST OF REFERENCE NUMERALS

1 endless tubular film
2a, b intake
3a, b third weld seam on the endless tubular film 1
4a, b inner liner of the apparatus, in which decanting is to be performed
5 transition film
6a second weld seam of contamination-free embodiment
7 bag
8a, b second weld seam of sterile embodiment
9 partition seam
10 token (waste part)
16 sealing film

1. A method for decanting bulk goods and solids (material), while avoiding contamination, from a facility having a preferably flexible outlet into a downstream apparatus having a weldable intake of an inner liner in the form of a tubular film, wherein the method has the following method steps:
situating an endless tubular film which is weldable on its outer side and inner side, the inner side being peelable after welding, around the outlet, welding the endless tubular film at its free end,
situating the intake around the outer side of the endless tubular film so that an intake-side edge of the intake comes to rest above a welded point of the endless tubular film, preferably pushing back material from the endless tubular film in the direction of the facility,
welding the endless tubular film to the intake, so that at least one continuous new second weld seam arises on the endless tubular film between its existing weld seam and the intake-side edge of the intake, which, on the one hand, connects the inner side of the intake to the outer side of the endless tubular film and, on the other hand, connects the inner side of the endless tubular film at the same point,
subsequently detaching the peelable inner side of the endless tubular film, so that the decanting procedure occurs until the endless tubular film is welded through again at a third point and in this way prevents the material flow and/or the possibility of a material flow.

2. The method according to claim 1, wherein the welding is performed at the third point so widely, and subsequently a cutting through of the endless tubular film is performed in the area inside the weld seam, preferably approximately centrally, after which a new filling/decanting procedure may then occur again in a new apparatus, or the welding is implemented at the third point as a double weld seam having central partition seam.

3. The method according to claim 1, wherein a tubular film carrier which encloses the outlet is situated around the outlet to receive the endless tubular film.

4. The method according to claim 1, wherein the welding is performed using pulse welding technology, and/or before the welding, the endless tubular film is pressed together using clamping bars, so that the material in the area of the later weld seam is displaced upward or downward as much as possible in the endless tubular film.

5. A device for the contamination-free decanting of bulk materials and in particular for performing the method according to claim 1, wherein the device comprises a facility having an outlet, around which the weldable endless tubular film, which is peelable on its inner side, is mounted as a supply, which is weldable on its outer side to the inner side of the intake of the inner liner of an apparatus into which decanting is to be performed.

6. The device according to claim 5, wherein compression bars are provided below the free end of the outlet and laterally to its imaginary elongated spatial longitudinal extension, which press together the endless tubular film laterally until it touches, the welding device preferably being situated integrated in these compression bars.

7. The device according to claim 6, wherein the welding device is a pulse welding device and/or it also comprises a cutting device, which can preferably cut through the endless tubular film approximately in the middle of the weld seam.

8. The device according to claim 5, wherein the endless tubular film comprises polyethylene and/or is folded in the axial direction in a delivery state and is preferably held using a slip brake at its mounting location in order to retain the outlet against unintentional slipping.

9. The device according to claim 5, wherein the endless tubular film is folded up axially.

10. A welable endless tubular film, which is peelable on its inner side, for the decanting of materials from a facility into an apparatus, in accordance with the method of claim 1.

11. The endless tubular film (1) according to claim 10, wherein the endless tubular film is mounted around the outlet of the facility so it can be pulled out and is to be welded in the pulled-out state to an intake of an inner liner of an apparatus into which decanting is to occur.

12. The endless tubular film according to claim 10, wherein the endless tubular film is connected to a bag in order to allow sterile decanting.

13. The endless tubular film according to claim 10, wherein the endless tubular film is a replacement part for decanting devices.

14. The endless tubular film is for producing a bag, preferably as an everted transition film.

15. A method for sterile decanting of powders or solids and/or materials, while avoiding contamination, from a facility having flexible outlet into a downstream apparatus having a weldable intake of an inner liner, in the form of a tubular film, of an apparatus for receiving materials, wherein the method has the following method steps:
situating an internally sterile endless tubular film, which is weldable on its outer side and inner side, the inner side being peelable after welding, around the sterile outlet, welding the endless tubular film on its free end, adapting a sterilized bag to the intake of the inner liner and sterilizing the bag with inner liner, the bag having been constructed as follows prior to its welding to the intake of the inner liner:
a tubular transition film, which is internally non-weldable and is already externally weldable, is weldable on its outer side to the inner side of the intake and is connected using its side facing away from the intake to a bag-shaped sealing film, whose bag floor lies inside the transition film and whose bag edge is connected, for example, welded, to the side of the transition film facing away from the intake, a plastic which is well weldable being selected for the sealing film;
situating the bag-shaped sealing film around the outer side of the endless tubular film so that the welded part of the endless tubular film comes to rest inside the bag;
preferably pushing back material from the endless tubular film in the direction of the facility,
welding the endless tubular film to the sealing film, so that at least one continuous new weld seam, preferably a double weld seam arises on the endless tubular film between its existing weld seam and a free edge of the sealing film, which, on the one hand, connects the inner side of the sealing film to the outer side of the endless tubular film and, on the other hand, connects the inner side of the endless tubular film at the same point, a partition seam being placed during this welding procedures in the middle of the weld seam, preferably between the double weld seams, so that the part of the endless tubular film facing away from the outlet is cut off in the form of a token, which encloses material, including the sealing film encompassing it, subsequently detaching the peelable inner side of the endless tubular film at its second welded point, so that the decanting procedure occurs until the endless tubular film is welded through again at a third point and thus prevents the material flow.

16. The method according to claim 15, wherein the sealing film is selected from pure polyethylene.

17. The method according to claim 15, wherein the bag is tightly welded to the intake, sterilized, preferably Y-sterilized, and provided as an accessory to the decanter.

18. The method according to claim 15, wherein the welding at the third point of the endless tubular film is performed so widely, and subsequently the cutting through of the endless tubular film occurs in the area inside the weld seam, preferably approximately centrally, after which a new filling/decanting procedure may occur in a new apparatus, or a double weld seam having central partition seam is applied on the endless tubular film at the third point.

19. The method according to claim 15, wherein the token is removed through the outlet.

20. A device for the sterile decanting of bulk materials, while avoiding contamination, and in particular for performing a method according to one of the preceding claims, characterized in that it comprises a facility having an outlet, around which a weldable endless tubular film, which is peelable on its inner side, is mounted as a supply, which is connected using its outer side to the inner side of a bag-shaped sealing film, which is welded to a tubular transition film, the latter being welded to the intake of an inner liner of an apparatus, into which decanting is possibly to be performed.

21. The device according to claim 20, wherein the bag-shaped sealing film is implemented together with the tubular transition film as a bag, which is connected fixed to the intake of the inner liner and sterilized.

22. A use of an internally weldable and peelable endless tubular film, in particular according to claim 1, for the decanting of transplantable organs, tissues, or the like in medicine and/or surgery.
